(19) United States
(12) Patent Application Publication
(10) Pub. No.: US 2025/0164983 A1
(43) Pub. Date: May 22, 2025

(54) SITE ACCEPTANCE TEST GENERATION SYSTEMS AND METHODS

(71) Applicant: Universal City Studios LLC, Universal City, CA (US)

(72) Inventors: Carlos Enrique Belardo, Orlando, FL (US); Dennis Gebken, Orlando, FL (US); Kevin Anthony Smith, Apopka, FL (US)

(21) Appl. No.: 18/671,665

(22) Filed: May 22, 2024

Related U.S. Application Data
(60) Provisional application No. 63/599,921, filed on Nov. 16, 2023.
(60) Provisional application No. 63/556,979, filed on Feb. 23, 2024.

(51) Int. Cl. G05B 23/02

(52) U.S. Cl. CPC G05B 23/0221; G05B 23/0216; G05B 2223/06

(57) ABSTRACT

A system to facilitate inspection of an attraction in an environment includes a processing system with one or more processors and memory storing instructions executable by the processing system to cause the processing system to receive a source file from a server, wherein the source file prescribes one or more target specifications for one or more operational characteristics of a component of the attraction. The instructions are executable by the processing system to cause the processing system to generate a site acceptance test (SAT) for the component based on the source file, wherein the SAT includes one or more inspection criteria that correspond to the one or more operational characteristics of the component.

### CROSS-REFERENCE TO RELATED APPLICATIONS

This application claims priority to U.S. Provisional Application No. 63/599,921, entitled “SITE ACCEPTANCE TEST GENERATION SYSTEMS AND METHODS,” filed Nov. 16, 2023, and U.S. Provisional Application No. 63/556,979, entitled “SITE ACCEPTANCE TEST GENERATION SYSTEMS AND METHODS,” filed Feb. 23, 2024, which are hereby incorporated by reference in their entireties for all purposes.

### BACKGROUND

The subject matter disclosed herein relates to entertainment attractions, and more specifically, to inspecting components of the entertainment attractions.

Entertainment environments (e.g., venues) may include various entertainment attractions for guests (e.g., families and/or people of all ages). For example, the entertainment attractions may include a roller coaster, a motion simulation ride with a vehicle on a motion platform, a show, and so forth. In addition, there may be themed areas within the entertainment environments. For example, the themed areas may include a hotel with a rustic theme, a restaurant with a party theme, and so forth. The entertainment attractions and the themed areas may include various types of equipment (e.g., vehicles, sensors, motors, brakes, props, decorations, animated figures). It is presently recognized that it would be desirable to develop systems and methods to efficiently test and/or inspect the various types of equipment.

### BRIEF DESCRIPTION

Certain embodiments commensurate in scope with the present disclosure are summarized below. These embodiments are not intended to limit the scope of the disclosure, but rather these embodiments are intended only to provide a brief summary of possible forms of present embodiments. Indeed, present embodiments may encompass a variety of forms that may be similar to or different from the embodiments set forth below.

In one embodiment, a system to facilitate inspection of an attraction in an environment includes a processing system with one or more processors and memory storing instructions executable by the processing system to cause the processing system to receive a source file from a server, wherein the source file prescribes one or more target specifications for one or more operational characteristics of a component of the attraction. The instructions are executable by the processing system to cause the processing system to generate a site acceptance test (SAT) for the component based on the source file, wherein the SAT includes one or more inspection criteria that correspond to the one or more operational characteristics of the component.

In another embodiment, a method to facilitate inspection of an attraction of an environment receiving, at a processing system, a source file corresponding to a component of the attraction, wherein the source file prescribes a target specification for an operational characteristic of the component. The method also includes generating, via the processing system of the user device, a site acceptance test (SAT) based on the source file, wherein the SAT includes an inspection criterion that corresponds to the operational characteristic. The method further includes receiving, at the processing system and from an input device of a user device, a user input indicative of an inspection value corresponding to the inspection criterion.

In another embodiment, an inspection system a first electronic device configured to store a source file corresponding to a component of an attraction, wherein the source file prescribes a target specification for an operational characteristic of the component. The inspection system also includes a second electronic device communicatively coupled to the first electronic device, wherein the second electronic device is configured to receive a user input indicative of a request to generate a site acceptance test (SAT) for the component based on the source file and to generate the SAT for the component based on the source file, wherein the SAT includes an inspection criterion that corresponds to the operational characteristic

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an embodiment of an entertainment environment that may utilize an inspection system, in accordance with certain aspects of the present disclosure;

FIG. 2 is a schematic of an embodiment of the inspection system of FIG. 1, in accordance with certain aspects of the present disclosure;

FIG. 3 is a flow diagram of an embodiment of a method of operating the inspection system of FIG. 1, in accordance with certain aspects of the present disclosure;

FIG. 4 is an illustration of an embodiment of a site acceptance test (SAT) that may be generated by the inspection system of FIG. 1, in accordance with certain aspects of the present disclosure; and

FIG. 5 is an illustration of an embodiment of a graphical user interface (GUI) that may be generated by the inspection system of FIG. 1, in accordance with certain aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is now recognized that it is desirable to facilitate time-efficient and non-laborious inspection of components implemented within an entertainment environment, such as within an attraction of an amusement park. In this manner, it may be possible to ensure that new components that may be installed at the attraction or used components previously installed at the attraction are operating in accordance within desired target specifications (e.g., operating specifications) and are providing designated functionality (e.g., voltage output, current output, torque output, force output, audio/visual output). As such, prompt and accurate inspection of the components may enhance an overall operational reliability of the attraction.

Accordingly, embodiments of the present disclosure are directed to an inspection system for components within an entertainment environment, such as within an attraction of an amusement park. The attraction of the amusement park may be assembled from various individual components that cooperate to facilitate operation of the attraction. For example, the attraction may include a ride vehicle configured to travel along a path (e.g., a track) during a ride stage of the attraction. The ride vehicle may be assembled from (e.g., constructed of) various individual components that collectively enable the ride vehicle to propel along the track, to receive one or more passengers (e.g., guests), to output audio and/or video media, and so forth. As such, the components may include relays, motors (e.g., electric motors), variable speed drives (VFDs), and/or other suitable components, systems (e.g., integrated or connected components), assemblies (e.g., groupings of components), and/or sub-assemblies (e.g., sub-groupings of components) that may be configured to enable effective operation of the ride vehicle. The components may be manufactured by one or more suppliers (e.g., vendors) tasked with the design, assembly, and/or delivery of the components for installation at the attraction.

It may be desirable to perform inspections (e.g., site acceptance tests [SATs]) on the components (e.g., of the ride vehicle) to ensure that the components are operating in accordance with desired operating specifications, to ensure that the components perform a desired functionality, and so forth. Performance of the SATs may be undertaken by an operator configured to evaluate whether installation of the components (e.g., on the ride vehicle of the attraction) is complete and accurate, whether the components are appropriately integrated within the attraction (e.g., with a control architecture of the attraction, with hardware or software of the attraction), whether parameters (e.g., operating parameters, manufacturing tolerances) of the components are within a target range, and/or to evaluate any other suitable parameters or characteristics of the components.

In some cases, vendors may provide a respective source file that corresponds to each of, or a subset of, the components installed in the attraction. The source file may include operational specifications (e.g., target specifications) corresponding to a particular component(s). That is, the source file may define desired operational characteristics or outputs of the component(s) that, when achieved, are indicative of the component(s) functioning properly. The inspection system disclosed herein is configured to generate, based on the source file, an SAT (e.g., an SAT file) that may be used by a technician (e.g., an operator) to evaluate aspects of the component(s) in the attraction, or to evaluate any other suitable parameters or characteristics of the component(s), in an enhanced and time-efficient manner. It should be appreciated that the specification may be vendor owned or owned by a third party (e.g., other than the vendor).

While the aforementioned introductory example has been given with reference to inspection of a ride vehicle, as discussed herein, it should be appreciated that the inspection system disclosed herein may be used to generate SATs for any suitable component(s) (including any suitable system, assembly, and/or sub-assembly) that may be implemented in an entertainment environment and/or in other settings (e.g., industrial settings, education settings, residential settings). For example, it should be appreciated that techniques disclosed herein are applicable to and may be implemented in any of a variety of environments, including any of a variety of entertainment environments (e.g., sports stadiums, theatres, restaurants) and/or other environments (e.g., manufacturing facilities, schools, homes).

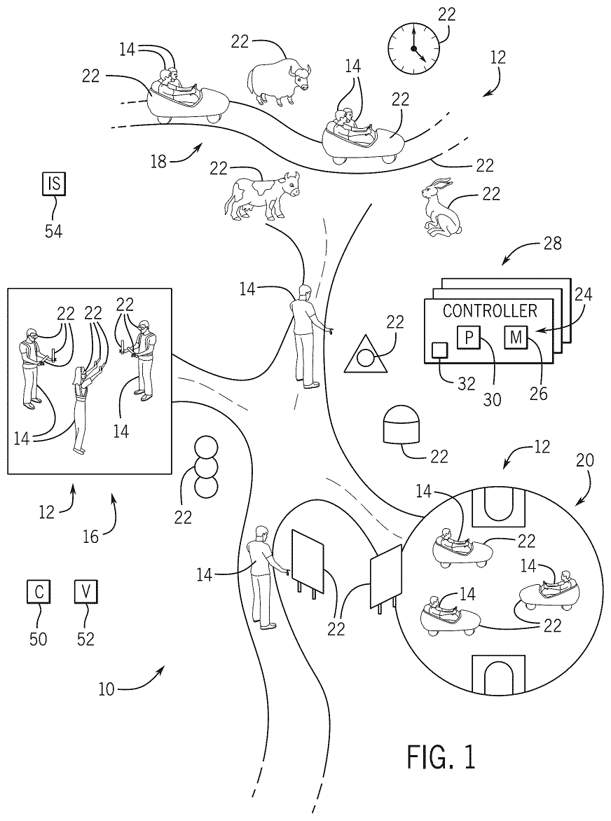

With the foregoing in mind, FIG. 1 illustrates an embodiment of an entertainment environment 10 (e.g., amusement park). The entertainment environment 10 includes one or more attractions 12 that accommodate multiple users 14 (e.g., guests, patrons). As shown, the one or more attractions 12 include a first attraction 16, a second attraction 18, and a third attraction 20. However, it should be understood that the entertainment environment 10 may include any suitable number of attractions 12.

Each attraction 12 may include any suitable number of hardware components 22 (e.g., animated figures, actuators, input devices, output devices), such as physical components that may use and interact (e.g., communicate) with software components 24. The software components 24 may be stored in memory 26 of one or more controllers 28. In an embodiment, each attraction 12 may be associated with a respective controller 28.

Each controller 28 may employ a processor 30, such as an application-specific processor. The controller 28 may also include the memory 26 for storing instructions executable by the processor 30 to perform the methods and control actions described herein. The processor 30 may include one or more processors, and the memory 26 may include one or more tangible, non-transitory, machine-readable media. By way of example, such machine-readable media can include RAM, ROM, EPROM, EEPROM, CD-ROM, or other optical disk storage, magnetic disk storage or other magnetic storage devices, or any other medium that can be used to carry or store desired program code in the form of machine-executable instructions or data structures and that may be accessed by the processor 30 or by any general purpose or special purpose computer or other machine with a processor.

The controller 28 may be communicatively coupled to elements of the entertainment environment 10 through a communication system 32. In some embodiments, the communication system 32 may communicate wirelessly. By way of non-limiting example, such communication may involve a wireless network (e.g., wireless local area networks [WLAN], wireless wide area networks [WWAN]), near field communication [NFC], or Bluetooth. Additionally or alternatively, the communication system 32 may use wired communication, such as a wired network including a local area network [LAN], or wide area network [WAN].

Each hardware component 22 may be categorized as an input device and/or an output device. That is, each hardware component 22 may be an input device, an output device, or an input/output device. An input device may receive an input, such as from one of the multiple users 14, and send input signals indicative of the received input to the controller 28. The hardware components 22 may include interactive components, and the input may be received via one or more user input devices (e.g., buttons, knobs, touchscreens, joysticks, actuatable elements, steering controls, triggers) of the interactive components.

Correspondingly, and as a result of the input signals, the output devices may receive the input signals, which may be received from the controller 28 and/or directly from the input devices. For example, the controller 28 may then, in turn, send one or more signals to one or more locations, such as the output devices, within the entertainment environment 10 to provide an appropriate response according to the received input. The output devices may react accordingly to the signal, such as through actuation of a device, through display of images/information via a display device or via any suitable visual experience generator, and so forth. For example, with regard to the hardware components 22 of the first attraction 16, input devices may include augmented reality (AR) and/or virtual reality (VR) devices (e.g., AR/VR devices), such as AR/VR tools and head mounted displays (HMDs), and output devices may include the HMDs as images are displayed via the HMDs.

With regard to the hardware components 22 of the second attraction 18, input devices may include ride devices (e.g., tools) that the users 14 may interact with during a ride cycle, and output devices may include animated show pieces and ride vehicles. With regard to the hardware components 22 of the third attraction 20, input devices may include steering wheels, and output devices may include a scoreboard and a game floor display. However, it is to be understood that the entertainment environment 10 may include any suitable number of attractions 12 with any suitable number and type of hardware components 22. Further, AR/VR devices may serve as input/output devices (e.g., hardware components 22) that facilitate user interaction with the attraction 12 to generate the input and cause another hardware element to output a response.

One or more of the hardware components 22 and one or more of the software components 24 may be collectively be referred to herein as components 50. As such, it should be understood that the components 50 may include individual components (e.g., mechanical components, electrical components, electromechanical components, hydraulic components), a system of components (e.g., a power transmission system; assembly), and/or a sub-system of components (e.g., a variable speed drive for an electric motor; sub-assembly). Further, the components 50 may include the one or more controllers 28 and sub-components of the one or more controllers 28 (e.g., hardware components, software components). In any case, the components 50 may cooperate to provide the features and functionality of the entertainment environment 10. That is, the components 50 may interact with one another in a manner that enables suitable operation of the first attraction 16, the second attraction 18, and the third attraction 20, and/or other suitable attractions 12 of the entertainment environment 10, for example. As an additional non-limiting example, the components 50 may include encoders, variable frequency drives, relays, contactors, two channel trap keys, two channel selector switches, two channel seatbelts, two channel radio frequency identification (RFID) devices, two channel push buttons, two channel key switches, two channel magnetic gates, two channel emergency-stop (E-stop) push buttons, pilot lights, alarm horns, restraints (e.g., seatbelts), power supplies, proximity sensors, brake resistors, fuses, circuit breakers, auto-voltage testers, and/or three-position mode switches.

In an embodiment, it may be desirable to test a functionality of the components 50 to ensure that the components 50 are operating adequately. For example, a site acceptance test (SAT) may be performed at a site of operation (e.g., customer site) to test the functionality of the components at the site of operation and to confirm that the components meet engineering specifications when operated at the site of operation. The SAT may be carried out in addition to and separately from (e.g., after) a factory acceptance test (FAT), which may be performed at a site of manufacture (e.g., warehouse; manufacturing or assembly facility) to test the functionality of the components at the site of manufacture and to confirm that the components meet engineering specifications in order to be shipped or delivered to the site of operation. Further, the SAT may be carried out in addition to and separately from (e.g., before) routine inspection for preventive maintenance of the components at the site of operation. For example, the SAT may generally involve more steps and/or rigorous testing at commissioning of the components (e.g., as part of installation of an attraction or machine; prior to use of the attraction or machine by guests), as compared to periodic routine inspection for preventive maintenance of the components over time (e.g., between uses of the attraction or machine by the guests). Further, certain types of components may be subject to a respective SAT, but not to periodic routine inspection for preventive maintenance. For example, certain software applications may be subject to a respective SAT prior to implementation and release for use at the site of operation (e.g., by the guests), but may not be routinely inspected for preventive maintenance purposes. Thus, generally the SAT validates installation and functionality of the components, as well as confirms that the components fit or match parameters set forth in specifications. Additionally, as described herein, the specifications may be provided by a vendor 52, and in some cases may be set forth in terms of a contract with the vendor 52. While certain examples herein refer to the vendor 52 to facilitate discussion, it should be appreciated that the specifications may be provided by any suitable entity or entities, such as the vendor 52, the other third party, any supplier, and/or a purchasing or receiving party (e.g., owner and/or operator of the components at the site of operation; owner and/or operator of the entertainment environment 10 and/or the one or more attractions 12). Further, it should be appreciated that the purchasing or receiving party may interact with any of the vendor 52, the other third party, and/or any supplier to share information and provide efficient SAT operations.

With this in mind, it may be beneficial to inspect whether current operational characteristics of the components 50 fall within corresponding operational bands (e.g., predetermined target specifications) of the components 50. For example, it may be desirable to test a functionality of certain components 50 (e.g., new components) that may be purchased from the vendor 52 and installed on one or more of the attractions 12 (e.g., by the vendor 52). The vendor 52 may be a supplier configured to manufacture, produce, provide, and/or maintain one or more of the components 50 and/or the attractions 12. Additionally or alternatively, it may be desirable to test currently installed components 50 on the attractions 12 during periodic maintenance intervals (e.g., after a threshold number of operational cycles, after lapse of a threshold time period) to ensure desired functionality of such components 50. Accordingly, present embodiments are directed toward an inspection system 54 that is configured to facilitate inspection and/or testing of the components 50 in a time efficient and/or non-arduous manner. Moreover, as discussed herein, the inspection system 54 may reduce an amount of computational resources that may be involved in generating tests and/or performing inspections on the components 50, as compared to conventional techniques. As such, the inspection system 54 may increase a speed at which tests and/or inspections on the components 50 may be undertaken and/or may increase a speed at which such tests and/or inspections may be modified (e.g., revised) based on site-specific demands or implementations.

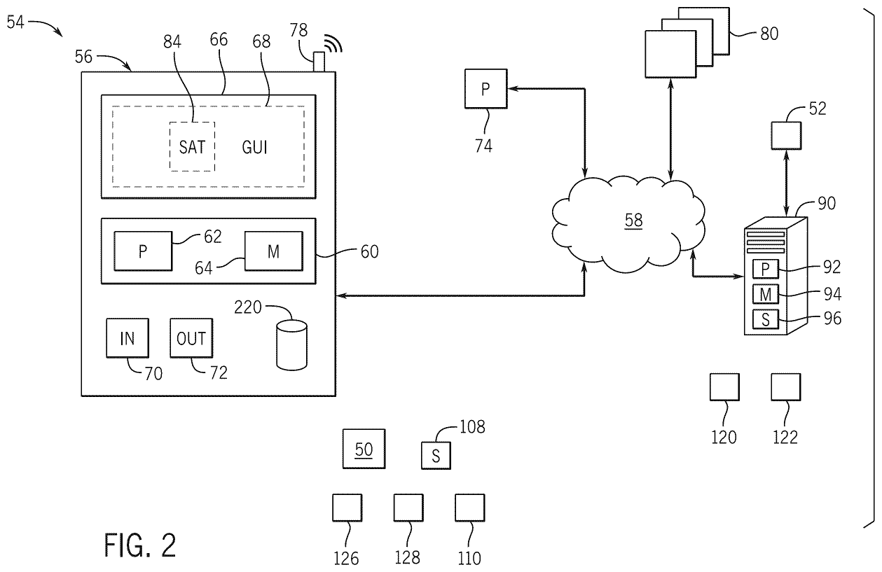

FIG. 2 is a block diagram of an embodiment of the inspection system 54. In the illustrated embodiment, the inspection system 54 includes a user device 56 (e.g., an electronic device) that may be communicatively coupled (e.g., wirelessly coupled) to a network 58 (e.g., a wireless network, a wireless local area network, a wireless wide area network, near field communication, and/or or Bluetooth). The user device 56 may include a cellular phone, a laptop, a tablet, a desktop computer, or another suitable electronic device. The user device 56 includes processing circuitry 60 (e.g., having a processor 62 and memory 64) that may be configured to perform some of or all of the techniques disclosed herein. The processor 62 may execute software (e.g., executable instructions, code) for controlling the inspection system 54 in accordance with the techniques disclosed herein. The processor 62 may include multiple microprocessors, one or more “general-purpose” microprocessors, one or more special-purpose microprocessors, and/or one or more application specific integrated circuits (ASICS), or some combination thereof. For example, the processor 62 may include one or more reduced instruction set (RISC) processors.

The memory 64 (e.g., a memory device) may store information, such as instructions, control software, look up tables, configuration data, and so forth. The memory 64 may include a volatile memory, such as random access memory (RAM), and/or a nonvolatile memory, such as read-only memory (ROM). The memory 64 may store a variety of information and may be used for various purposes. For example, the memory 64 may store processor-executable instructions including firmware or software for the processor 62 to execute, such as instructions for controlling the inspection system 54. In an embodiment, the memory 64 is one or more tangible, non-transitory, machine-readable-media that may store machine-readable instructions for the processor 62 to execute. The memory 64 may include ROM, flash memory, a hard drive, or any other suitable optical, magnetic, or solid-state storage medium, or a combination thereof. The memory 64 may store data, instructions, and/or any other suitable data.

The user device 56 may include a display 66 (e.g., a screen) and the processor 62 may be configured generate a graphical user interface (GUI) 68 on the display 66. The GUI 68 may enable an operator (e.g., a service technician of the entertainment environment 10 of FIG. 1) to utilize and control the inspection system 54. For example, in some embodiments, the GUI 68 may be configured to receive one or more user inputs (e.g., from a user of the inspection system, such as the operator) in order to facilitate operation of the inspection system 54 in accordance with the techniques disclosed herein. Additionally or alternatively, the user device 56 may include one or more input devices 70 and/or one or more output devices 72 that may enable the user to provide a user input to the processor 62 and/or to receive user-understandable outputs (e.g., visual outputs on the display 66, audio outputs) from the processor 62.

In an embodiment, the one or more input devices may include a keyboard, a mouse, a pen, a touch input device, an audio input device (e.g., a microphone), a gestural input device, a haptic input device, an image or video capture device (e.g., a camera), or other devices. The one or more output devices 72 may include the display 66, one or more light emitting diodes (LEDs), an audio output device (e.g., a speaker), a haptic output device, and so forth. The input devices 70 and/or the output devices 72 may be physically incorporated with the processor 62 or may be external with respect to the processor 62. In an embodiment, the output devices 72 may include a printer 74 that may be communicatively coupled to the user device 56 (e.g., via the network 58).

In the illustrated embodiment, the user device 56 includes a communication component 78 (e.g., one or more network interfaces) that enable communication between the user device 56 and other components (e.g., electronic devices, servers, additional user devices 80, and/or any other devices in or associated with the entertainment environment 10) that may be communicatively coupled to the network 58. The network interface(s) may include one or more network interface controllers (NICs) or other types of transceiver devices configured to send and receive communications over one or more networks using any network protocol.

As discussed in detail herein, the user device 56 may be configured to facilitate generation of one or more site acceptance test (SATs) 84 that may enable the operator to inspect or otherwise perform testing on the components 50. The SAT 84 may be indicative of a process (e.g., an inspection checklist; a list of steps; in a list format) that enables the operator to ensure that the components 50 achieve or exceed designated design criteria (e.g., target operating specifications). The operator may perform inspection of a particular component 50 (e.g., using the SAT 84) prior to installation of the particular component 50 on one or more of the attractions of the entertainment environment 10. Additionally or alternatively, the operator may perform the inspection of the particular component 50 (e.g., using the SAT 84) subsequent to installation and integration of the particular component 50 on a corresponding attraction.

The user device 56 may be configured to display the SAT 84 to the operator via the display 66 (e.g., via the GUI 68). As such, the operator may receive data (e.g., user-readable data or instructions) from the SAT 84 and may input data into the SAT 84 (e.g., using the GUI 68). In an embodiment, the user device 56 may be configured to send instructions to the printer 74 or another suitable device to print a physical copy of the SAT 84 for utilization by the user.

In an embodiment, the user device 56 may be configured to generate the SAT 84 based on source files 96 (e.g., data) received from a server 90 that may be communicatively coupled to the network 58. The server 90 may include a processor 92 and memory 94 The server 90 be hosted by the owner and/or the operator of the entertainment environment 10 and/or the one or more attractions 12 of FIG. 1. The server 90 or at least a portion thereof (e.g., storage; database) may be accessible to the vendor 52, such as via communication between one or more vendor devices (e.g., a vendor server; a vendor computing system, such as a desktop computer) of the vendor 52. For example, the vendor 52 may use the one or more vendor devices to generate the source files for the particular component 50, and then the one or more vendor devices may provide the source files from the one or more vendor devices to the server 90, such as via the network 58.

In any case, the server 90 may include the source files 96 corresponding to one or more of the components 50. The source files 96 may include data related to desired target operational outputs, functionalities, and/or specifications of the components 50. The user device 56 may be configured to receive and utilize the source files 96 to generate, based on the source files 96, suitable SATs 84 that may be used by the operator to test (e.g., inspect) the operational outputs, functionalities, and/or specifications of the components 50 prior to and/or after installation of the components 50 on an attraction of the entertainment environment 10. As noted herein, the SAT 84 may be indicative of a process (e.g., an inspection checklist) for review and to instruct the operator to perform certain actions and tasks. It should be appreciated that the SAT 84 may include text arranged in phrases and/or sentences (e.g., complete phrases and/or sentences; similar to or matching natural or spoken language) that form instructions readable by the operator, and the text of the SAT 84 may be arranged in a format (e.g., list and/or table format; separated into distinct steps of a list; each step is provided in a distinct row and/or a column of a table) to facilitate review and understanding by the operator, for example. Additionally, it should be appreciated that the text of the SAT 84 and/or the format of the SAT 84 is different than the text and/or format (e.g., structured data; data exchange format; code; programming language) of the source file 96. Generally, the text of the SAT 84 and/or the format of the SAT 84 are easier to read and understand by the operator, while the text and/or format of the source file 96 facilitates storage and/or efficient data exchange. For example, techniques disclosed herein may generate a large number of SATs 84 (e.g., over 50 SATs 84) in a period of time (e.g., less than 3, 5, or 10 seconds). Further, the large number of SATs 84 may be output together (e.g., via one PDF) and/or viewable in one session (e.g., via swipe and/or selection from a menu to view the different SATs 84).

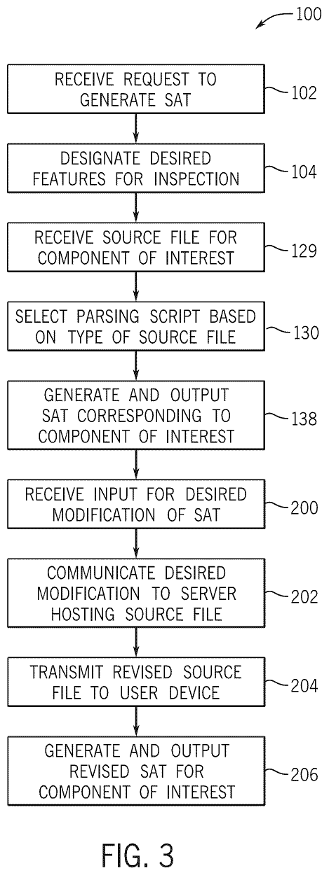

To facilitate the following discussion, FIG. 3 is flow diagram of an embodiment of a process 100 for operating the inspection system 54 to generate one or more SATs 84, in accordance with the presently disclosed techniques. It should be noted that the steps of the process 100 may be performed in any suitable order and are not limited to the order shown in FIG. 3. Moreover, it should be noted that additional steps of the process 100 may be performed, and certain steps of the process 100 may be omitted. The process 100 may be executed by the processors 62 and/or 92, and/or on other suitable processing components of the inspection system 54. The process 100 may be stored on, for example, memory 64 and/or the memory 94, or on another suitable memory device of the inspection system 54. For clarity, it should be understood that, throughout the following discussion, reference to the user device 56 performing an action, providing an output, or receiving an input, may be indicative of the processor 62 of the user device 56 performing that action, providing that output, or receiving that input. FIGS. 2 and 3 will be referenced concurrently throughout the following discussion.

The process 100 may begin with receiving a request to generate an SAT 84 (e.g., an SAT file), as indicated by block 102. For example, a user may utilize the user device 56 to input (e.g., via the GUI 68, via the input devices 70) a command (e.g., instructions) to generate the SAT 84 for a particular component 50 (e.g., a component of interest). In an embodiment, the user device 56 may prompt the user to designate desired features of the component 50 for which inspection is desired, as indicated by block 104. For example, the user device 56 may prompt the user to specify a type of failure mode of the component 50 the user wishes to inspect, a grouping or one or more operational characteristics of the component 50 the user wishes to inspect, software and/or hardware configurations of the component 50 the user wishes to inspect, and so forth.

As discussed herein, the server 90 may receive and/or store source files 96 that respectively correspond to the components 50. For example, in an embodiment, each of the components 50 may be associated with one or more corresponding source files 96 stored on the server 90. The source files 96 may define one or more target specifications (e.g., target values) for one or more operational characteristics of the components 50. The source files 96 may be received by the user device 56, as indicated by block 129. For example, the user device 56 may transmit a request to the server 90 to receive the source file 96 for a particular component 50 and, in response to the request, the server 90 may transmit the source file 96 to the user device 56 (e.g., via the network 58). As noted herein, the source files 96 may be generated via the one or more vendor devices, and then communicated to the server 90 for storage and/or use to generate the SAT 84. The owner and/or the operator of the entertainment environment 10 and/or the one or more attractions 12 of FIG. 1, as well as the vendor 52, may have access to the server 90 (or at least to a portion of the server 90, such as a database that stores the source files 96, the SATs 84, various versions of the SATs 84, and so forth). This architecture (e.g., hardware, communication pathways, access, permissions) may enable efficient sharing of information between the owner and/or the operator and the vendor 52, as well as provide a shared workspace or storage space for the owner and/or the operator and the vendor 52.

As a non-limiting example, in an embodiment, the component 50 may be a sensor 108 incorporated in one of the attractions of the entertainment environment 10. The source file 96 corresponding to the sensor 108 may indicate target specifications for one or more operational characteristics of the sensor 108. The operational characteristics may include, for example, an output voltage of the sensor 108, an output current of the sensor 108, a resistivity of the sensor 108 (e.g., a value of an electrical resistance across terminals of the sensor 108), a start-up time of the sensor 108 (e.g., after a short circuit test), an operating channel of the sensor 108 (e.g., the communication port or protocol through which the sensor 108 is communicatively coupled to corresponding processing circuity), and/or any other suitable operating parameter of the sensor 108. As such, the source files 96 may prescribe target specifications (e.g., desired target values) for various operational characteristics of the components 50.

It should be understood that the source files 96 may designate target specifications (e.g., target values) for operational characteristics of the components 50 that the components 50 are expected to experience during an active or energized state, as well for operational characteristics that the components 50 are expected to experience during an inactive or de-energized state. For example, in an embodiment, one of the components 50 may include a motor 110 (e.g., an electric motor). In such embodiments, the server 90 may store a designated source file 96 that corresponds to the motor 110. The source file 96 may, for example, prescribe a desired target specification (e.g., target value) for an operational torque of the motor 110 while the motor 110 is energized (e.g., via a threshold voltage and/or current). As such, the source file 96 may specify a target specification for an operational parameter of the motor 110 that occurs or is induced by operation of the motor 110 (e.g., when the motor 110 is in an active or energized state). Additionally or alternatively, such active operational parameters of the motor 110 may include an operating temperature of the motor 110, axial and/or radial vibrations of a shaft of the motor 110, a magnetic flux induced during operation of the motor 110, and so forth. In certain embodiments, the source file 96 may additionally or alternatively prescribe a target specification for an operational parameter of the motor 110 that occurs or is exhibited by the motor 110 when the motor 110 is in an inactive or non-energized state. As an example, such an operational parameter may include a resistivity (e.g., electrical resistivity) across windings (e.g., stator windings, rotor windings) of the motor 110. Therefore, it should be appreciated that the source files 96 may prescribed a multitude of desired target specifications for certain operational characteristics of the components 50 that may occur during active states of the components 50, as well as during idle or inactive states of the components 50.

In an embodiment, one or more of the components 50 may be associated with multiple source files 96, which the inspection system 54 may utilize in accordance with the present techniques to generate the SAT 84. For example, a component 50 (e.g., a component 50 for which inspection is desired) may be associated with a first source file 120 that identifies the component 50 and the target specifications corresponding to the operational characteristics of the component 50. The component 50 may further be associated with a second source file 122 that defines tests that may be run (e.g., by the operator, by a testing device) to, as discussed in detail herein, ensure that the operational characteristics of the component 50 are within the desired target specifications. The first source file 120 and the second source file 122 corresponding to the component 50 may collectively be referred to as the source file 96 of that component 50. As such, it should be appreciated that a source file 96 for a particular component 50 may be formed from and/or otherwise include 1, 2, 3, 4, 5, or more than 5 individual source files.

In an embodiment, the server 90 may be configured to store various types (e.g., data types; a first type, a second type, a third type, and so forth) of source files 96. For example, in certain embodiments, the source files 96 may include JavaScript Object Notation (JSON) files that are configured to store data indicative of the target specifications for the components 50. Additionally or alternatively, one or more of the source files 96 may have a different base-file type. In an embodiment, the user device 56 may be configured to determine the type of source files 96 received by the user device 56 (e.g., from the server 90) and to select a parsing script (e.g., code, processor-executable instructions) with which to parse (e.g., read, analyze, process) the source files 96 based on the type of source files 96 received by the user device 56 (e.g., from the server 90), as indicated by block 130.

For example, in an embodiment, the user may utilize the user device 56 to request SATs 84 for multiple components 50 (e.g., a first component 126 and a second component 128). As such, the server 90 may provide the user device 56 with a first type of source file 96 (e.g., a JSON file) that may be associated with the first component 126 and a second type of source file (e.g., a non-JSON file) that may be associated with the second component 128. The user device 56 may identify (e.g., select) and utilize a first script, corresponding to the first source file, to parse the first source file in accordance with the present techniques to generate a respective SAT 84 for the first component 126. Similarly, the user device 56 may identify (e.g., select) and utilize a second script, corresponding to the second source file, to parse the second source file in accordance with the present techniques to generate a second SAT 84 for the second component 128.

Upon selection of a corresponding parsing script (e.g., python script), the user device 56 may generate and output the SAT 84 for the component 50 (e.g., transform or convert the source file 96 into the SAT 84), as indicated by block 138. For example, the user device 56 may use the corresponding parsing script, such as python script, to parse the source file 96, such as a JSON file, to generate and output the SAT 84, which may be a portable document file (PDF) or other printable and/or modifiable file type. In an embodiment, the user device 56 may display the SAT 84 as a user modifiable form (e.g., via the display 66), which may be configured to receive and store user inputs. For example, the user device 56 may display the SAT 84 via the GUI 68. The user device 56 may generate the SAT 84 based on the one or more target specifications indicated in the source file 96 for the one or more operational characteristics of the component 50.

As an example, the source file 96 may specify a grouping (e.g., one or more) of operational characteristics of the component 50 and corresponding target specifications for these particular operational characteristics. Based on the grouping of operational characteristics, the user device 56 may generate (e.g., in the SAT 84) one or more inspection criteria that correspond to the one or more operational characteristics in the grouping of operational characteristics. The inspection criteria may include desired tests to be performed by an operator, desired measurements to be taken by the operator, other desired data to be acquired by the operator, and/or other suitable tasks to be performed by the operator to enable inspection of the component 50 (e.g., tests, measurements, data, and/or tasks to be initiated, performed, supervised, and/or managed by the operator). In particular, the inspection criteria may enable the user device 56 to provide an indication as to whether values of the measured operational characteristics of the component 50 currently under inspection fall within a desired range (e.g., a threshold range) of the target specifications for those characteristics (e.g., as defined in the source file 96 for the corresponding component 50).

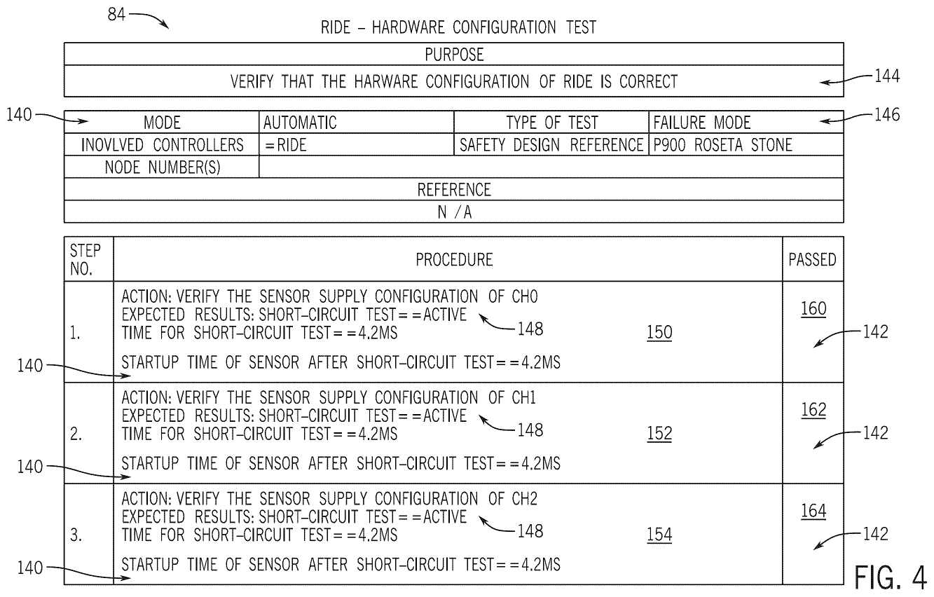

To better illustrate and to facilitate the following discussion, FIG. 4 is a schematic of an embodiment of an SAT 84 that may be generated by the user device 56. The user device 56 may generate the SAT 84 based on the source file 96 for a particular component 50. In the illustrated embodiment, the SAT 84 includes multiple information fields 140 and multiple data entry fields 142. The information fields 140 may display information related to the component 50 for which testing is desired (e.g., a component 50 that the operator intends to inspect). For example, the information fields 140 may include a descriptor field 144 configured to identify the component 50, a test type field 146 configured to identify a test to be performed on the component 50 by the operator (e.g., a failure test), and one or more procedure fields 148. Each of the procedure fields 148 may provide information related to a particular test to be performed on the component 50.

For example, the procedure fields 148 may include a first row 150, a second row 152, and a third row 154, which may each include information corresponding to a test or inspection to be performed on the component 50. In an embodiment, the procedure fields 148 may include information including, but not limited to, desired inspection criteria of the component 50 to be inspected by an operator (e.g., verifying that a sensor is appropriately configured), a testing methodology to be employed by the operator to perform the test or inspection relating to the inspection criteria, an expected result (e.g., result values) to be identified via performance of the test or inspection, and/or an expected time period that may be involved to perform the test or inspection on the component 50. Although the illustrated embodiment of FIG. 4 illustrates the SAT 84 as having three rows of procedure fields 148, it should be appreciated that the user device 56 may be configured to generate an SAT 84 (e.g., based on the source file 96) that includes any suitable quantity of procedure fields 148.

In the illustrated embodiment, the SAT 84 includes the multiple data entry fields 142, which may be utilized by the operator to input one or more inspection values of the component 50, where such inspection values may be determined during performance of the tests or inspections specified in the procedure fields 148. For example, in an embodiment, the SAT 84 may include a data entry field 142 that corresponds to a respective one of the procedure fields 148. As such, the SAT 84 may include a first data entry field 160 corresponding to the first row 150, a second data entry field 162 corresponding to the second row 152, and a third data entry field 164 corresponding to the third row 154. The following discussion continues with reference to the first row 150 and the first data entry field 160. However, it should be appreciated that the described methodology may be implemented with respect to each set of procedure fields 148 and data entry fields 142.

As discussed herein, the user device 56 may generate the SAT 84 based on the corresponding source file 96 (e.g., as received from the server 90) of the component 50. In an embodiment, the source file 96 may designate a test or type of inspection to be performed on the component 50 to identify and examine designated operational characteristics of the component 50. The user device 56 may, based on this test or inspection data designated in the source file 96, generate the SAT 84 to specify (e.g., in the first row 150) the steps or techniques an operator should perform to complete the test or inspection on the component 50 to verify whether the designated operational characteristic of the component 50 are within target specifications (e.g., target ranges). That is, the first row 150 may include instructions indicating the types of inspection criteria (e.g., tests, measurements, visual inspections) an operator is to examine in order to evaluate whether the one or more operational characteristics specified in the source file 96 are within the target specifications corresponding to those operational characteristics.

In an embodiment, the user device 56 may generate the SAT 84 in a manner that displays (e.g., in the first row 150) the target specification for a particular operational characteristic of the component 50. The user device 56 may further request that an operator (e.g., a user of the user device 56), upon conducting the appropriate test on the component 50, input a value corresponding to a measured value (e.g., an actual value) of the operational characteristic (e.g., an inspection criterion) in the first data entry field 160. Upon receipt of the measured value of the inspection criterion, the user device 56 may compare the measured value to the target specification of the operational characteristic to determine whether the measured value is within the target specification. For example, the user device 56 may be configured to determine whether the measurement value of the inspection criterion of the component 50 (e.g., as input by the operator via the first data entry field 160) is within a threshold value or within a threshold range of the corresponding target specification. In response to a determination that the measurement value of the inspection criterion of the component 50 is within the target specification, the user device 56 may provide a notification (e.g., audio notification, visual notification, or both) to the operator. For example, the user device 56 may adjust a color of the first data entry field 160 (e.g., to a green color) or mark the first data entry field 160 with a status indication (e.g., a “PASSED” notification). In response to a determination that the measured value of the inspection criterion of the component 50 is outside of the target specification (e.g., deviates from the target specification), the user device 56 may output an alert to the operator (e.g., an audio alert, a visual alert, or both). As an example, the user device 56 may adjust a color of the first data entry field 160 (e.g., to a red color) or mark the first data entry field 160 with a status indication (e.g., a “FAILED” notification).

The following discussion continues with reference to FIGS. 2 and 3. In an embodiment, an operator may, upon review of the SAT 84 generated by the user device 56, desire that certain modifications, incorporations, or adjustment be made to the SAT 84. For example, the operator may instruct the user device 56 to incorporate additional procedure fields 148 to the SAT 84, to remove procedure fields 148 from the SAT 84, to include additional or fewer inspection criteria in the SAT 84, and so forth. The operator may input the desired modifications to the SAT 84 via the user device 56 (e.g., using the GUI 68). As such, the user device 56 may receive an input (e.g., instructions) for modification of the SAT 84, as indicated by block 200. Upon receipt of the instructions to modify the SAT 84, the user device 56 may communicate (e.g., wirelessly transmit) the desired modifications for the source file 96 (e.g., corresponding modifications to the source file 96) to the server 90 that may host the source file 96 (e.g., an initial source file, an unmodified source file), as indicated by block 202.

Thus, the server 90 may store the source file 96 (e.g., the initial source file, the unmodified source file) and/or an updated version of the source file 96 (e.g., also referred to herein as “an updated source file 96”) based on the desired SAT 84 modifications that were input by the operator via the user device 56. In one embodiment, the updated source file 96 may be communicated to the one or more vendor devices for visualization and/or notification to the vendor 52. For example, in response to generating the updated source file 96 and/or storing the updated source file 96, an alert may be provided to the one or more vendor devices for visualization and/or notification to the vendor 52. It should be appreciated that the alert may take any suitable form, such as a text message presented via an application running on the one or more vendor devices, presentation of the updated source file 96 in a list of available versions of the source files 96, and so forth.

Advantageously, this enables the updated source file 96 to be utilized in subsequent test procedures by the owner and/or the operator of the entertainment environment 10 of FIG. 1 and/or to be available for use by the vendor 52. For example, upon updating the source file 96, the server 90 may store and/or transmit the updated source file 96 (e.g., a revised source file, an updated source file, a modified source file corresponding to the component 50 for which inspection is desired) to the user device 56, as indicated by block 204. Upon receipt of the updated source file 96, the user device 56 may generate and output (e.g., via the GUI 68) an updated version of the of the SAT 84 (e.g., also referred to herein as “an updated SAT 84”) for the component 50. The updated SAT 84 may be considered to be a revised SAT or a modified SAT that includes the requested modification to the original, previous SAT 84, as set forth by the operator in block 200. That is, the user device 56 may generate, based on the updated version of the source file 96 received from the server 90, the updated SAT 84 for the component 50, as indicated by block 206.

By updating the source file 96 based on the desired modifications to the SAT 84 (e.g., instead of only updating the SAT 84 directly), the inspection system 54 may enable other user devices 80 to receive (e.g., from the server 90) the updated source file 96, and use the updated source file 96 to generate the updated SAT 84. In this manner, other operators, who may be inspecting components similar or identical to the component 50 (e.g., using corresponding user devices 80; at other attractions; at later times), may utilize the updated source file 96 to generate the updated SAT 84 that has already been modified by a previous operator. As such, the individual operators need not each update the SAT 84 on their corresponding user devices 80 and, instead, may retrieve the updated source file 96 from the server 90 and generate the updated SAT 84 based on the already updated source file 96 stored on the server 90. Further, the vendor 52 has access to the updated source file 96 stored on the server 90, which may enable the vendor 52 to adjust processes and/or otherwise utilize the updated source file 96.

Additionally or alternatively, the updated source file 96 may be made available to the user device 56 at some later time, such as during a subsequent inspection. In this manner, the inspection system 54 may reduce a time period that may be involved in updating SATs 84 across various user devices 56, 80, as well as reduce an amount of computational resources that may be involved to generate the SATs 84 (e.g., by offloading modification of the source file 96 from the user devices 56, 80 to the server 90), as well as provide consistency in tests performed over time and/or across attractions. For example, without the disclosed techniques, a vendor may send multiple documents (e.g., PDFs and/or printed documents) with test protocols to the operator; however, if there is a mistake in the multiple documents, the operator may make comments on each of the multiple documents and then the vendor would update each of the multiple documents (e.g., this could be a time consuming process, such as several days). Advantageously, with the disclosed techniques, the operator may request a modification (e.g., at the user device 56), all affected source files 96 may be efficiently updated (e.g., by updating the JSON data one time), and then all of the SATs 84 may be regenerated, as well as printed and/or displayed as desired.

In an embodiment, the user device 56 may be configured to adjust a display priority (e.g., a display order, a data display priority) of the procedure fields 148 of the SAT 84 based on historical inspection data (e.g., historic inspection values) related to the component 50. For example, in some embodiments, the user device 56 and/or the server 90 may be configured to store inspection data 220 (e.g., one or more historic inspection values) related to previous tests or inspections conducted by the operator on the component 50. That is, the user device 56 may log, for example, that a test associated with the first row 150 of one or more previous SATs 84 produced a satisfactory or unsatisfactory result. The user device 56 may be configured to order the rows of a current SAT 84 based on such historical inspection data 220 of prior SATs 84. For example, the user device 56 may configure a current SAT 84 such that rows associated with prior tests yielding non-satisfactory results (e.g., in which one or more examined operational characteristics of a component 50 deviate from the corresponding target specifications) are positioned above (e.g., relative to the GUI 68) other rows of the SAT 84. As such, an operator may be directed to first inspect certain operational characteristics of the component 50 that are known to have had previously unsatisfactory performance (e.g., and thus are more likely to have unsatisfactory performance) before moving on to inspection of alternate operational characteristics. In this manner, the user device 56 may be configured to generate subsequent SATs 84 based on one or more historic inspection values (e.g., the historical inspection data 220) and the source file 96 corresponding to the particular component 50 under inspection, for example.

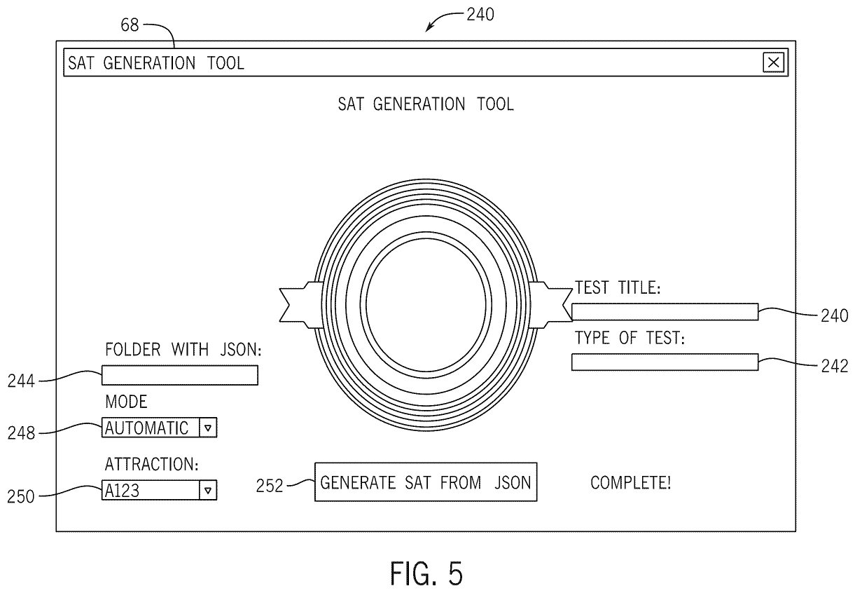

FIG. 5 is an illustration of an embodiment of a user interface 240 that may be provided via the GUI 68. That is, the user device 56 may generate and display the user interface 240, such that the user interface 240 may form at least a portion of the GUI 68. In the illustrated embodiment, the user interface 240 includes a first data section 242, a second data section 244, a third data section 246, a fourth data section 248, a fifth data section 250, and an initiation icon 252. A user of the user device 56 may utilize the user interface to facilitate generation of a SAT 84 for a particular component 50. The first data section 242 may be configured to receive a user input designating a particular name or title to be assigned to the SAT 84. The second data section 244 may enable the user to designate (e.g., via a user input received at the user device 56) a desired type of test (e.g., a desired mode, such as failure mode analysis) to be included as part of the SAT 84. The third data section 246 may enable the user (e.g., via a user input received at the user device 56) to designate (e.g., select or provide some indication of) the source file 96 corresponding to the particular component 50 for which inspection is desired. The fourth data section 248 and the fifth data section 250 may enable the user to specify additional parameters related to generation of the SAT 84, such as an operating mode and/or attraction type corresponding to the SAT 84. To initiate generation of the SAT 84, the user may select (e.g., via the GUI 68) the initiation icon 252. Upon selection of the initiation icon 252, the user device 56 may send a request to the server 90 to receive, based on the inputs provided through the user interface 240, a corresponding source file 96 (e.g., one or more source files 96) that enable generation of an SAT 84 that conforms with the requested parameters set forth or input by the user via the user interface 240. That is, the user device 56 may execute the techniques set forth herein to generate the SAT 84 for the component 50.

It should be appreciated that certain aspects described herein as being performed by one processor (e.g., the processor 62) may be performed by any processor (e.g., the processor 92) and/or any combination of processors. Additionally, certain aspects described herein may be automated to facilitate generation, presentation, and/or completion of the SATs 84 in an efficient manner with fewer inputs from the user (e.g., communication with the components 50 and/or the one or more controllers 28 to carry out tests, such as to power on the component, and/or to obtain test results, such as sensor outputs or other data, which may then be used to populate a corresponding data entry fields 160). Additionally, a processing system (e.g., computing system) may include any processors (e.g., any combination of processors), including the processor 30, the processor 62, the processor 92, and/or any other processor. Operations described herein may be performed by the processing system, such as any of the processor 30, the processor 62, the processor 92, and/or any other processor (e.g., distributed between the processor 30, the processor 62, the processor 92, and/or any other processor). Further, the processing system and/or any of the processors therein, including the processor 30, the processor 62, the processor 92, and/or any other processor and/or any other related processing circuitry components, may include and/or be part of a cloud system (e.g., cloud computing system or functionality; distributed or remote computing system or functionality; accessed via a network, such as the Internet). Thus, the processing circuitry (e.g., the processor(s) and/or the memory device(s)) may be on-board and/or off-board respective devices (e.g., the processing circuitry 60 with the processor 62 and the memory 64 may include hardware and/or software components that are on-board the user device 56 and/or off-board the user device 56; communicatively coupled to one another via a network, such as the Internet).

As set forth herein, embodiments of the present disclosure may provide one or more technical effects useful for facilitating time-efficient and/or non-laborious inspection of components that may be implemented within an entertainment environment. As such, the disclosed inspection system may facilitate ensuring that new components installed on an attraction, or used components previously installed on the attraction, are operating in accordance within desired target specifications and are providing designated functionality. The technical effects and technical problems in the specification are examples and are not limiting. It should be noted that the embodiments described in the specification may have other technical effects and can solve other technical problems.

While only certain features and embodiments of the present disclosure have been illustrated and described, many modifications and changes may occur to those skilled in the art without materially departing from the novel teachings and advantages of the subject matter recited in the claims. The order or sequence of any process or method steps may be varied or re-sequenced according to alternative embodiments. It is, therefore, to be noted that the appended claims are intended to cover all such modifications and changes as fall within the true spirit of the present disclosure.

Furthermore, in an effort to provide a concise description of the exemplary embodiments, all features of an actual implementation may not have been described (i.e., those unrelated to the presently contemplated best mode of carrying out the present disclosure, or those unrelated to enabling the claimed embodiments). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system to facilitate inspection of an attraction in an environment, the system comprising:
a processing system comprising one or more processors; and
memory storing instructions executable by the processing system to cause the processing system to:
receive a source file from a server, wherein the source file prescribes one or more target specifications for one or more operational characteristics of a component of the attraction; and
generate a site acceptance test (SAT) for the component based on the source file, wherein the SAT includes one or more inspection criteria that correspond to the one or more operational characteristics of the component.

2. The system of claim 1, comprising a user device with a display configured to render a graphical user interface (GUI), wherein the instructions are executable by the processing system to cause the processing system to instruct the GUI to display the SAT to a user.

3. The system of claim 2, wherein the instructions are executable by the processing system to cause the processing system to receive, via the GUI of the user device, user inputs indicative of one or more inspection values corresponding to the one or more inspection criteria.

4. The system of claim 3, wherein the instructions are executable by the processing system to cause the processing system to instruct the user device to provide an alert in response to a determination that the one or more inspection values deviate from the one or more target specifications.

5. The system of claim 1, wherein the instructions are executable by the processing system to cause the processing system to:
determine a data type of the source file;
select a parsing script to parse the source file based on the data type of the source file; and
parse the source file using the parsing script to generate the SAT.

6. The system of claim 1, wherein the instructions are executable by the processing system to cause the processing system to:
receive, via an input device of a user device, a user input indicative of a desired modification to the SAT;
transmit the user input to the server;
receive, from the server, an updated source file generated based on the initial source file and the user input; and
generate an updated SAT based on the updated source file.

7. The system of claim 6, wherein the user input corresponds to a request to include an additional inspection criterion in the SAT, to remove an inspection criterion from the one or more inspection criteria, or both.

8. The system of claim 1, wherein the instructions are executable by the processing system to cause the processing system to:
access one or more historic inspection values corresponding to the one or more inspection criteria; and
generate, based on the one or more historic inspection values and the source file, an updated SAT for inspection of the component.

9. The system of claim 8, wherein the instructions are executable by the processing system to cause the processing system to adjust a data display priority in the SAT based on the one or more historic inspection values.

10. The system of claim 1, wherein the source file comprises a JavaScript Object Notation (JSON) file.

11. The system of claim 1, comprising a user device comprising the processing system and the memory, the user device is communicatively coupled to the server via a wireless communication protocol, and wherein the user device comprises a cellular phone, a laptop, a tablet, or a desktop computer.

12. The system of claim 1, wherein the server is a vendor server, a third party server, or both.

13. A method to facilitate inspection of an attraction of an environment, the method comprising:
receiving, at a processing system, a source file corresponding to a component of the attraction, wherein the source file prescribes a target specification for an operational characteristic of the component;
generating, via the processing system, a site acceptance test (SAT) based on the source file, wherein the SAT includes an inspection criterion that corresponds to the operational characteristic; and
receiving, at the processing system from an input device of a user device, a user input indicative of an inspection value corresponding to the inspection criterion.

14. The method of claim 13, comprising:
receiving, via the input device of the user device, a request to generate an updated SAT that includes one or more updated inspection criteria;
transmitting, via the processing system, instructions to update the source file based on the request;
receiving, at the processing system, an updated source file; and
generating, via the processing system, the updated SAT based on the updated source file for presentation to a user via the user device.

15. The method of claim 13, comprising:
storing, via the processing system, historical data corresponding to inspection results of prior inspections performed on the component of the attraction; and
adjusting, via the processing system and based on the historical data, a display prioritization of the inspection criterion for display at the user device.

16. The method of claim 13, comprising generating, via the processing system, an alert in response to a determination that the inspection value corresponding to the inspection criterion deviates from the target specification of the operational characteristic.

17. The method of claim 13, comprising:
selecting, via the processing system and based on a type of the source file, a parsing script to parse the source file; and
parsing, via the processing system, the source file using the parsing script to generate the SAT.

18. An inspection system, comprising:
a first electronic device configured to store a source file corresponding to a component of an attraction, wherein the source file prescribes a target specification for an operational characteristic of the component; and
a second electronic device communicatively coupled to the first electronic device, wherein the second electronic device is configured to receive a user input indicative of a request to generate a site acceptance test (SAT) for the component based on the source file and to generate the SAT for the component based on the source file, wherein the SAT includes an inspection criterion that corresponds to the operational characteristic.

19. The inspection system of claim 18, wherein the second electronic device is configured to receive an additional input corresponding to a value of the inspection criterion, and wherein the second electronic device is configured to determine whether the value is within the target specification of the operational characteristic of the component.

20. The inspection system of claim 18, wherein the component comprises an encoder, a variable frequency drive, a relay, a contactor, a selector switch, a restraint, a radio frequency identification (RFID) device, a push button, a key switch, a magnetic gate, an emergency-stop (E-stop) push button, a pilot light, an alarm, seatbelts, a power supply, a proximity sensor, a brake resistor, a fuse, a circuit breaker, an auto-voltage tester, or any combination thereof.
